(19) United States
(12) Patent Application Publication
(10) Pub. No.: US 2006/0019223 A1
(43) Pub. Date: Jan. 26, 2006

(54) Interactive foreign language teaching device and method

(75) Inventors: Michael C. Wood, Orinda, CA (US); Jonathan Dariyanani, San Francisco, CA (US); Chris D'Angelo, Danville, CA (US); Michael Ross, San Rafael, CA (US); Aaron Norstad, Walnut Creek, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 11/187,599

(22) Filed: Jul. 21, 2005

Related U.S. Application Data
(60) Provisional application No. 60/590,530, filed on Jul. 22, 2004.
(60) Provisional application No. 60/618,741, filed on Oct. 14, 2004.

(51) Int. Cl. G09B 19/00

(52) U.S. Cl. 434/156

(57) ABSTRACT

A method and device for teaching foreign languages is disclosed. The device can have an interactive user interface so that a language student can choose what percent of language in a passage is presented in the student's native language and what percent is presented in the language the student wishes to learn. The passage may be presented as audio or may be presented in visual form.

### CROSS-REFERENCES TO RELATED APPLICATIONS

This patent application is a non-provisional of and claims the benefit of U.S. Provisional Patent Application No. 60/590,530, filed on Jul. 22, 2004, and U.S. Provisional Patent Application No. 60/618,741, filed on Oct. 14, 2004, all of which are herein incorporated by reference in their entirety for all purposes.

### BACKGROUND OF THE INVENTION

Methods and products for teaching foreign languages are known. One such product is called “Spanish in 10 Minutes a Day”. It includes a workbook and stickers with foreign words. The stickers can be attached to household objects. It also has maps and a set of audio CDs that provide correct pronunciations of the foreign words. The workbook introduces new vocabulary by substituting foreign words into instructions.

Another product that is used to teach foreign language is the BBC Muzzy® Language Course for Children. It is produced on video tapes and on CD ROMs. It presents a video of a story in English, and then in a target foreign language. The user knows the content from the English presentation and can understand the immediately repeated story in the target foreign language. In some presentations, the words in the target foreign language are presented in a story setting filled with visual and song cues to help the user learn the meaning of the words. The Muzzy series has also produced an interactive CD ROM that presents a story segment in either the target language or in a native language.

U.S. patent application Ser. No. 10/371,489 (“the '489 application”), (Pub. No. 2004/0015360 A1) discloses a virtual book that is stored on a DVD. Page images are shown with an accompanying audio narration. The DVD is interactive as the user can make choices as to the desired target language. The user may also choose to participate in various activities (e.g., read-along or a sing along activities).

While the above-described foreign language systems are effective in some instances, a number of improvements could be made. For example, when using the “10 Minute Series”, a user must follow a workbook at the rate it presents its substitutions of target foreign language words into a native language text passage. A user cannot define the percentage of target foreign language word substitution. The Muzzy product and the system described in the '489 application present an entire story in either a native or target foreign language. There is no partial substitution of target foreign language words in a passage including native language words. With respect to the Muzzy product and the system described in the '489 application, when the entire story is presented to the user in the target language, the user is not likely to learn all of the target foreign language words, since it may be too much information for the user to absorb in a short period of time. The end result is that the user will have a difficult time learning the foreign language.

What is needed is a method and device that helps a user learn a foreign language more effectively than in the past.

### SUMMARY OF THE INVENTION

Embodiments of the present invention are directed to methods, devices, and memory media that are used for teaching foreign languages more efficiently and effectively than has been done in the past. Embodiments of the invention allow a user to gradually become immersed into a foreign language. The device can have an interactive user interface so that a language student can choose the percentage (or amount) of words in the user's target language and the user's native language in a passage such as a narrative passage. The passage may be presented to the user as audio and/or as text on a display device. When a user chooses to substitute a small percentage of target language words into a passage, individual target language words may be substituted for individual native language words. As the student chooses to have a larger percentage of target language words substituted in the passage, whole phrases in the target language may be substituted for native phrases. As the percentage of target language words increases relative to the percent of native language words, grammatical changes can also be introduced. This gradual immersion into the target foreign language allows the user to learn the target foreign language, without feeling like he or she is actively studying the target foreign language.

One embodiment of the invention is directed to a method comprising: presenting a passage to a user through an audio output device or display device, wherein the passage includes words in the user's native language and words in the user's target language; adjusting a percentage of words in the user's target language in the passage; and then presenting the passage to the user through the audio output device or display device using the adjusted percentage of words in the user's target language.

Another embodiment of the invention is directed to a memory medium comprising: code for presenting a passage to a user through an audio output device or display device, wherein a passage includes words in the user's native language and words in the user's target language; code for adjusting the percentage of words in the user's target language in the passage; and then code for presenting the passage to the user through the audio output device or display device using the adjusted percentage of words in the user's target language.

Another embodiment of the invention is directed to a foreign language learning device for learning a foreign language comprising: an audio output device and a display device adapted to provide a user-controllable presentation; and a memory medium coupled to the audio output and display devices, wherein the memory medium comprises code for audio for target language words and native language words in a passage, code for providing visual images related to and coordinated with the audio, and code for allowing a user to select a percentage of the target language words to be presented along with the native words in the passage.

These and other embodiments of the invention are described in detail below.

### BRIEF DESCRIPTION OF THE DRAWINGS

FIG. 1A shows a block diagram of a language teaching device according to an embodiment of the invention.

FIG. 1B shows a flowchart illustrating a method according to an embodiment of the invention.

FIG. 2A illustrates an exemplary selection menu screen displayed on one embodiment of the present invention.

FIG. 2B illustrates an alternative exemplary selection menu screen displayed on one embodiment of the present invention.

FIGS. 3, 4, and 5 illustrate scripts that have 5%, 35%, and 75% target language saturation, respectively.

FIG. 6A illustrates a visual image that could be used as a virtual dial to select a desired target language saturation percentage.

FIG. 6B illustrates a visual image that could be used as a virtual sliding switch to select a desired target language saturation percentage.

FIG. 6C illustrates a visual image of a cell phone that could be used to select a desired target language saturation percentage.

FIG. 7 illustrates samples of both substitution and juxtaposition of the target language words into native language passages in a displayed image.

FIG. 8 shows an image of a page of a book that can be used in embodiments of the invention.

### DETAILED DESCRIPTION

As will be described in further detail below, using embodiments of the invention, a user is gradually introduced to new words in a target foreign language by gradually substituting target foreign language words into a passage that includes native language words. Over time, the percentage of target language words in a passage including native language words increases. This gradual changing of words into the target foreign language helps a user learn the target foreign language. By mixing target foreign language words with native language words, the user better understands how the target foreign language words are used and better understands their meanings.

One embodiment of the invention is directed to a foreign language teaching device. The foreign languages that can be taught are not limited, and may include Spanish, French, German, Chinese, Japanese, English, Korean, etc.

As used herein, the foreign language that the user wants to learn is called the “target language” or “target foreign language”. A language in which the user has mastery is called the “native language”. The “user” may be a child or an adult. It is also contemplated that the “user” also includes a child with his or her parent helping that child operate the appropriate equipment to practice embodiments of the invention.

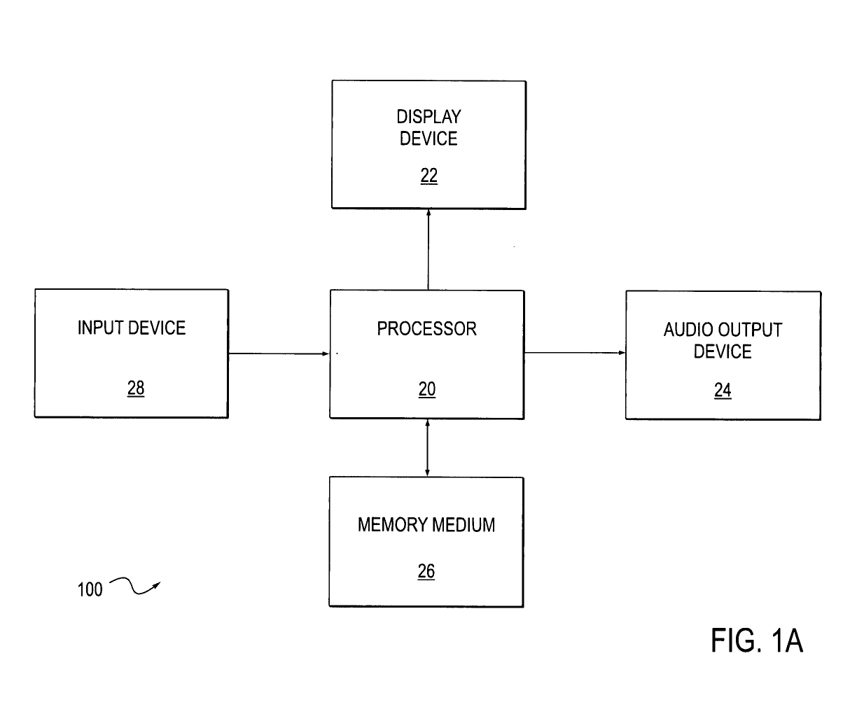

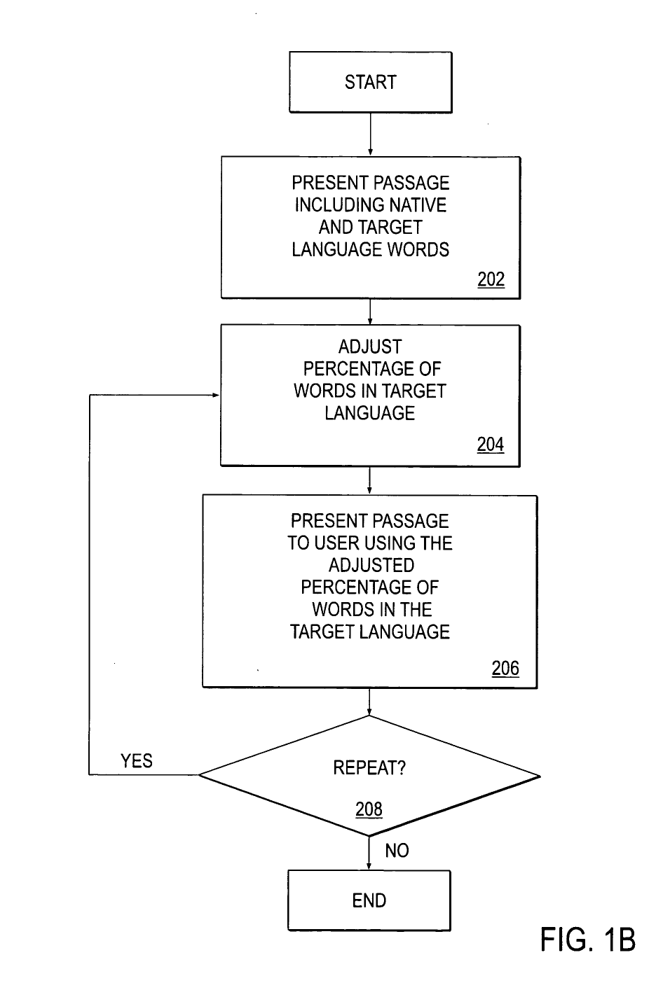

Referring to FIG. 1A, the language learning device 100 may comprise a processor 20 (e.g., a microprocessor) that is operatively coupled to a display device 22, an audio output device 24 (e.g., a speaker, earphone jack, etc.), a memory medium 26 (e.g., a CD-ROM, a DVD, a memory stick, etc.), and an input device 28 (e.g., a DVD controller, a mouse, a touchpad, etc.). Although the components in FIG. 1 are shown as separate functional blocks, they may be embodied by a single device or many different devices working together. For example, the language learning device 100 may be embodied by the combination of a television, a DVD player, and a DVD containing the computer code providing instructions for performing the methods according to embodiments of the invention. In another example, the device 100 could be embodied by a laptop computer with a hard drive and a display device, where the computer code sufficient to perform the methods according to embodiments of the invention is stored on the hard drive.

The audio output device 24 (e.g., a speaker) and the display device 22 (e.g., an LCD screen, a television screen, etc.) are adapted to provide an audio-visual presentation to a user. The presentation may be user controllable.

The memory medium 26 may store any suitable set of instructions. For example, the memory medium 26 may comprise code for storing, presenting, and/or manipulating target language words and native language words. The memory medium 26 may also include code for producing visual images using the display device 22, where the images are related to and coordinated with the audio. The memory medium 26 may also include code for allowing a user to select, either implicitly or explicitly, a percentage of target language words to be presented along with native language words in the passage.

The memory medium 26 may store audio information, visual information, or both in any suitable manner. Any suitable electrical, electro-optical, optical, or magnetic data storage medium may be used to store this information. The information that is played back by the language learning device 100 can include visual images, audio signals, or both. Preferably, both audio and visual information are stored on the memory medium 26 and the information is presented by the device 100 as an audio-visual presentation. The presentation of information by the language learning device 100 can be referred to as “playing back” the information.

The memory medium 26 may be a computer readable medium and may be in the form of a memory chip, disk, drive, etc. The memory medium is preferably in the form of a DVD disk, which stores the information in both visual and audio formats. DVDs are an enhanced form of CD-ROMs that hold a minimum of 4.7 gigabytes of data. The DVD specification supports disks with capacities of 4.7-17 GB and access rates of 600 KBps to 1.3 MBps. Typically, DVD technology uses a data compression standard such as MPEG-2 to compress video data for storage.

The information that is played back can be a passage of information. The passage of information may be a narrative passage or narration. “Passages” can include sentences, stories, articles, phrases, etc. The terms “narration” or “narrative passage” can refer to a story, news passage, or any other type of coherent group of words or sentences. As will be apparent from the description below, the narrative passage may mix native and target language words in amounts that can vary and/or that can be user-defined.

The passage is preferably a story that is suitable for children or adults. The story may relate to a popular story, series, or characters, and may have been made into a television program or movie. When the passage is a popular story (e.g., Jack and the Beanstalk) or cartoon, a user can listen to the passage multiple times while being entertained each time the story is read or shown. This helps language development.

In embodiments of the invention, the narrative passage may be presented to a user using both audio and video. However, the narrative passage could be presented to the user in only audio form, in only video form, or in some asymmetric combination of the audio and video.

If the information that is presented to the user is only in audio form, then the user may be instructed, for example, to press a skip key a certain number of times to play back the desired audio information. If the information that is presented to the user is in visual form, then the visual information can be displayed, for example, on the display of a monitor, a television screen, etc.

An exemplary flowchart illustrating some steps in a method according to an embodiment of the invention is shown in FIG. 1B. Referring to FIG. 1B, the language learning device can first present a passing including native and target language words to the user (step 202). A text passage and/or an audio passage with native and target language words may be presented to the user through a display device or audio output device. After the user has reviewed the passage, at a later time, the language learning device can adjust the percentage of words in the user's target language (step 204). As explained in detail below, this can be done at the user's prompting or can be performed automatically by the language learning device. After the percentage of target language words is adjusted, the adjusted percentage is used to create a new passage and this new passage is presented to the user (step 206). As the user progresses and learns the target language, the step of adjusting the percent of target words can be repeated (step 208). Further details regarding the method shown in FIG. 1B are provided below.

As noted above, the inventive language learning device presents a passage to the user. The passage includes varying amounts of native language words and target language words. The number of target language words in a passage relative to the total number of words in the passage is referred to as the percent of saturation or “saturation percentage”. For example, if a passage contains 100 words, and 5 of them are in the target language and 95 of them are in the native language, then the saturation percentage for the passage would be 5%. The saturation percentage of target language words for native language words in a passage is typically greater 1% and/or less than 99%. The saturation percentage may be 10, 20, 30, 40, 50, 60, 70, or 80 percent in other embodiments.

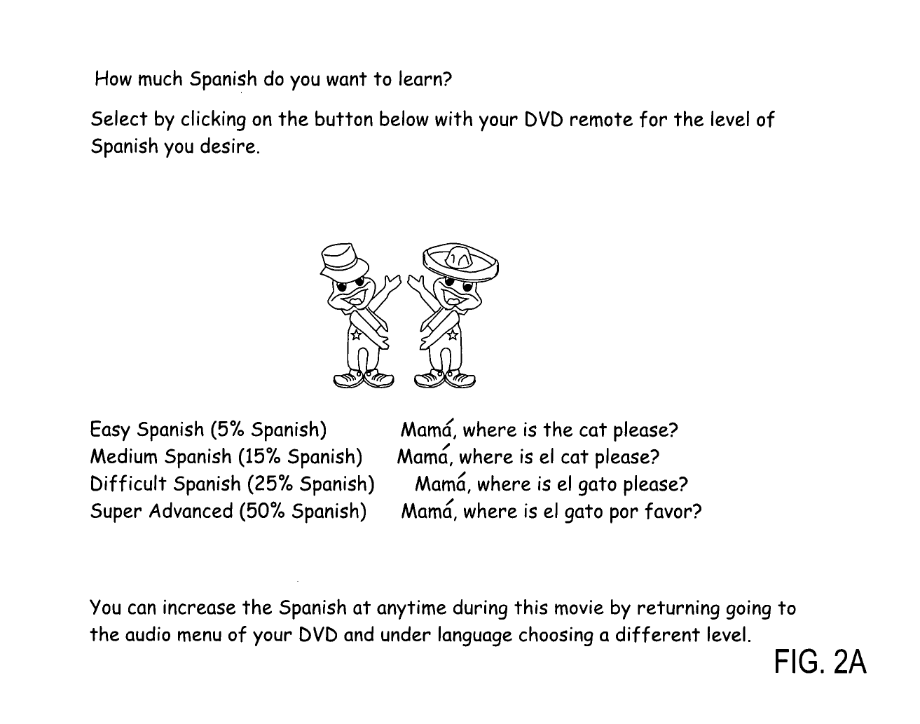

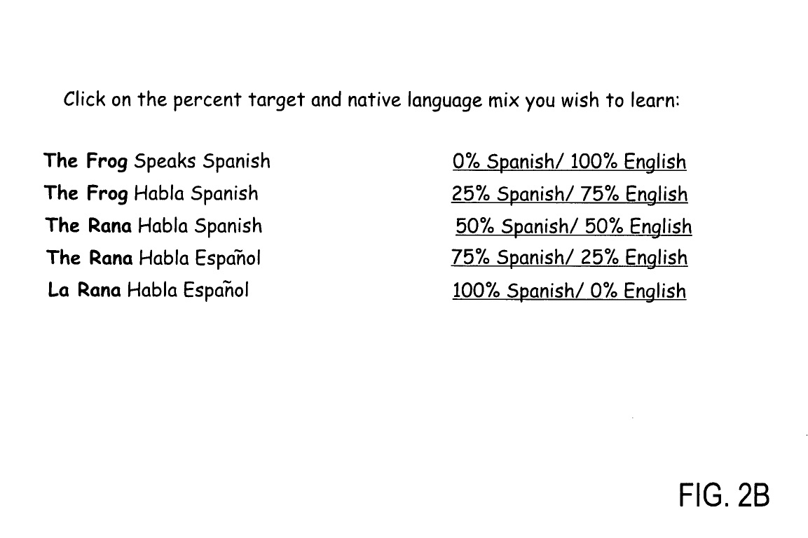

FIG. 2A illustrates an exemplary menu that allows a user to select the desired target language saturation level. The menu illustrates several different levels of target language saturation including 5%, 15%, 25%, and 50% Spanish. A user can initiate the presentation of information after choosing or selecting the desired level of saturation from the menu.

In one embodiment of the invention, a multimedia cartoon story is visually displayed on a display device. A user having no knowledge of a desired target language (e.g., Spanish), could begin by selecting an audio narration of the story that is presented entirely in the user's native language so that the user is familiar with the story. The saturation percentage in this case would be 0%. After the user becomes familiar with the story, the user may select an alternative increased saturation percentage. If the user selects, for example, 5% saturation, the same cartoon story would be presented. However, 5% of the spoken or displayed native language words would be converted into the user's target language, while the remaining 95% of the words in the story would remain in the user's native language. The spoken or displayed story consequently “mixes” target language and native language words in the story. The mix of target and native language words may change over time to help the user learn the target language.

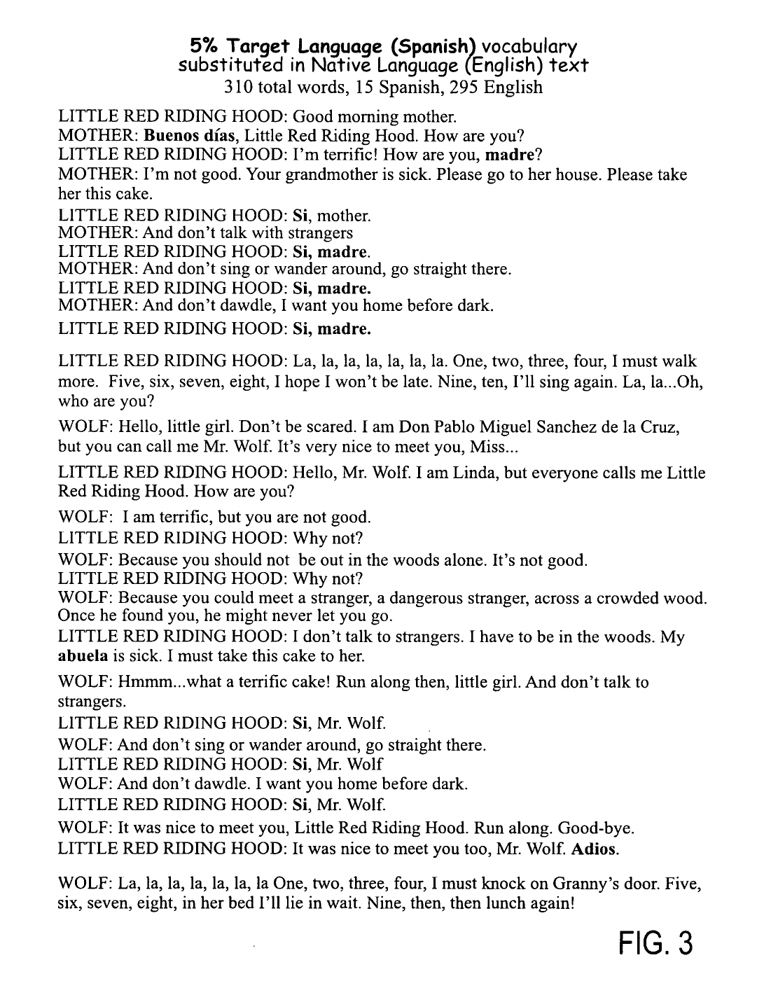

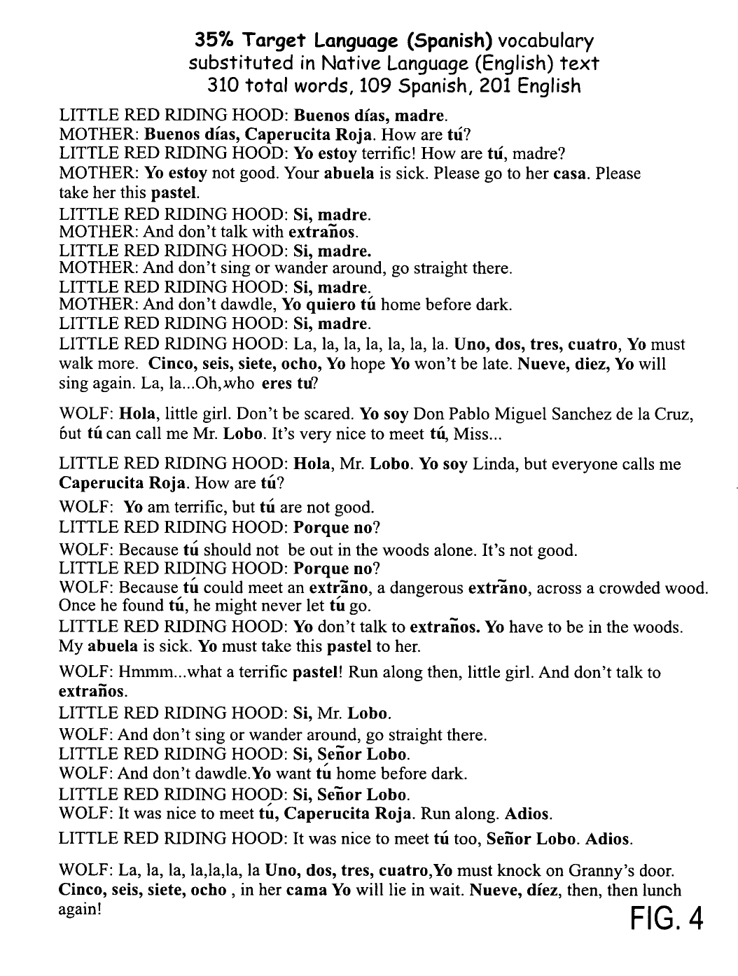

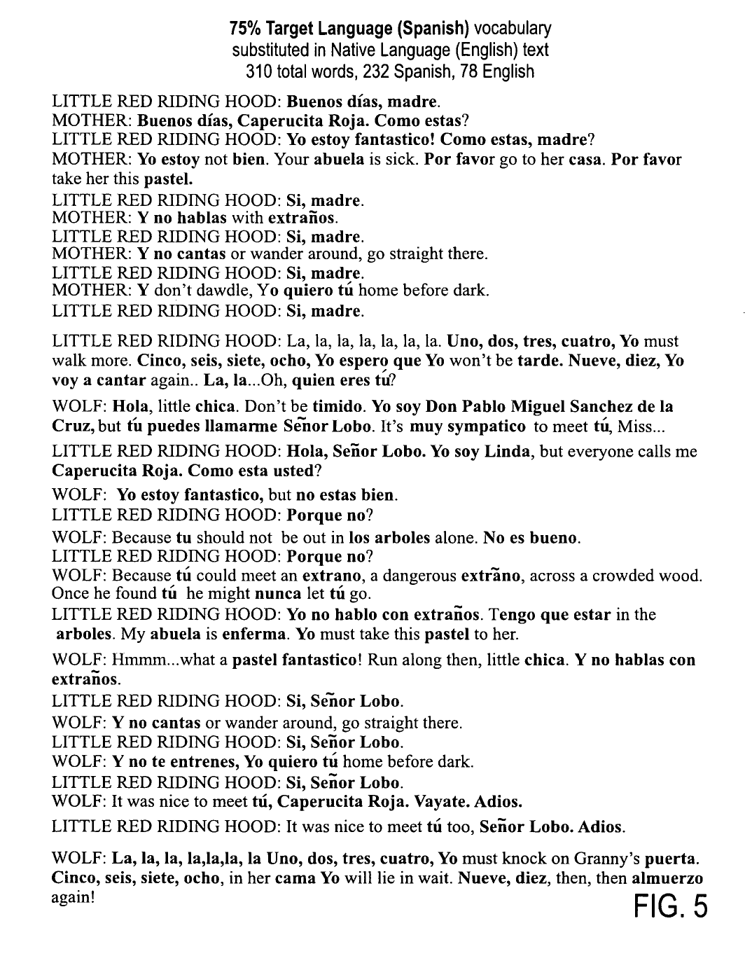

FIGS. 3-5 show the text of the story “Little Red Riding Hood” and respectively show increasing percentages of target language words in the story. FIGS. 3-5 show saturation percentages of 5%, 35%, and 75%, respectively. As is apparent from FIGS. 3-5, as the user's knowledge of the target language increases, there is a “gradual” increase in the number of target Spanish words in the story. The user can gradually become accustomed to the Spanish language and is able to understand the context of the Spanish words as they relate to a well known story.

The different passages with different saturation percentages (or amounts of saturation) may be embodied in a single program on a single medium. For example, different passages with different saturation levels may associated with a single DVD program on a single DVD. Alternatively, different passages with different saturation percentages may be present on respectively different media such as different DVDs, each DVD having a different passage with a different saturation percentage.

As the target language saturation percentage increases with each subsequent playback of a passage, certain phrases can be presented entirely in the target language. Substitution of a whole phrase instead of a word-for-word translation is particularly desirable in the case of idiomatic phrases, so that the user learns the foreign language idiomatic phrases. For example, a phrase such as “piece of cake” may be substituted throughout a narrative passage including this phrase so that the user understands that the phrase “piece of cake” is an idiomatic phrase.

A visual presentation of a passage may include text. The text may be presented so that it is coordinated with corresponding audio. For example, a synthesized voice may read the text in the passage. The level of coordination between the text and corresponding audio may be at the word level, the sentence level, etc. In some cases, the entire text of a passage could be present in a sidebar type display. Preferably, the text of a passage is displayed to the user so that it is coordinated with a phrase-by-phrase or line-by-line audio narration.

In some embodiments, the saturation percentage may be different for a text passage and for an audio passage. An extreme example would be 100% foreign language audio and 0% foreign language text, so that the native language text is displayed while the target language audio is played. Preferably, the saturation percentage of any displayed text of a passage would be the same or substantially the same as the saturation percentage of any audio corresponding to the passage.

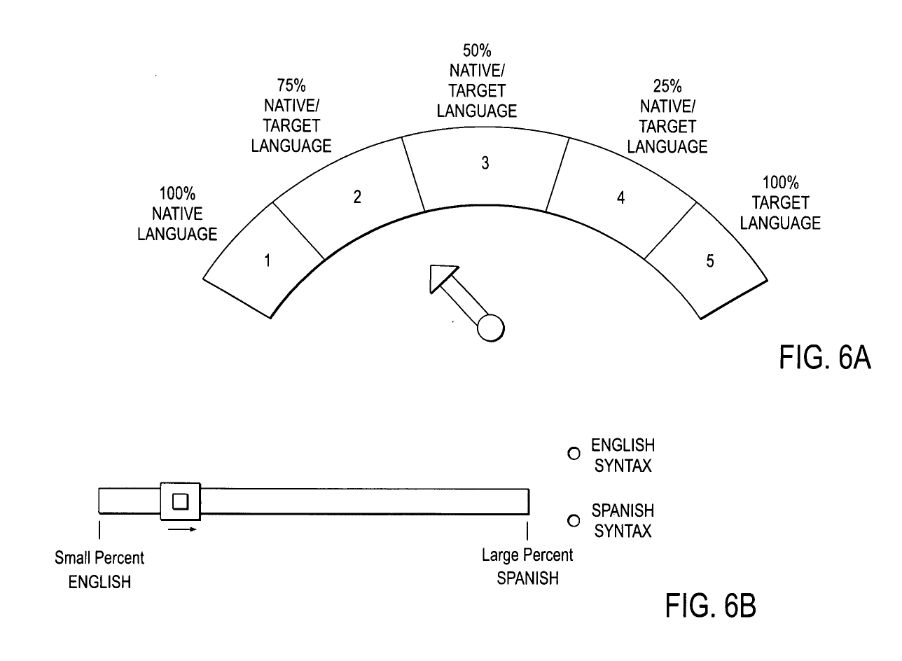

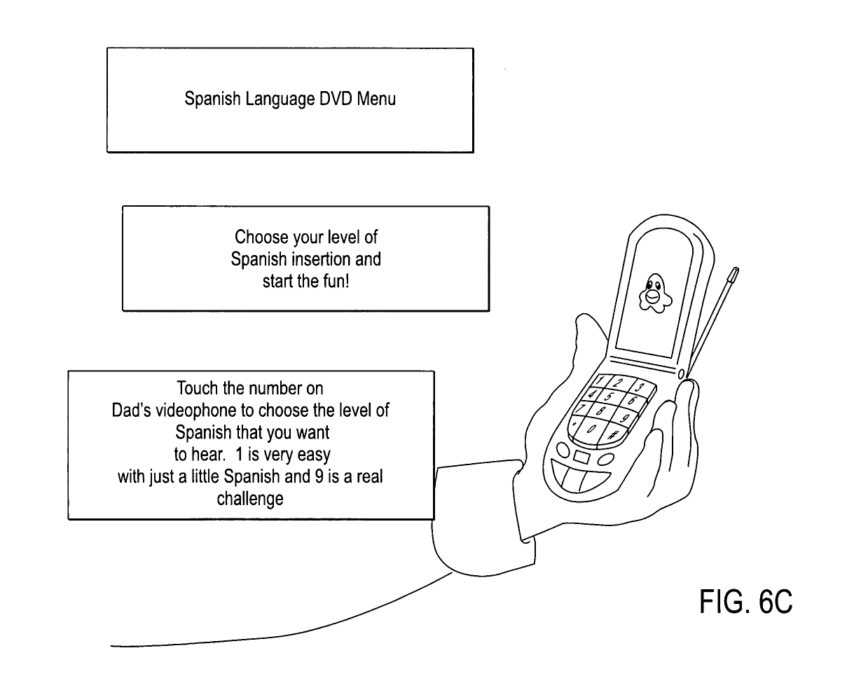

In some embodiments, the user can control the percentage of presented target foreign language words in a recited and/or displayed passage using a graphical user interface. For example, the user may select a saturation percentage using a visual image such as a virtual sliding switch or a virtual dial. Examples of such visual images are shown in FIGS. 6A, 6B, and 6C. The virtual switch or dial may explicitly recite saturation percentages (e.g., 10%, 20%, etc.), or may implicitly recite the saturation percentages. For instance, labels such as “easy”, “medium”, and “hard” may imply relative saturation percentages. In another example, FIG. 6C shows an example of an interactive DVD menu that might accompany a DVD. Viewers use the illustrated keypad to select various levels of Spanish audio insertion into an English language passage using a 1 through 9 scale. Selecting “1” might cause 2%-5% of the words in a passage to change to Spanish words. Selecting “9” might cause 50% of the words in the passage to change to Spanish words. The virtual switch or dial may also allow for discrete or continuous changes in saturation percentages. In each case, the user is selecting a saturation percentage.

In the embodiments illustrated in FIGS. 6A, 6B, and 6C, a saturation percentage may be manually selected by a user using an input device such as a wired or wireless DVD controller or a mouse. In other embodiments, the saturation percentage may be selected automatically by the language teaching device. For example, a computer may automatically increase the saturation percentage at the beginning of every day, week, or month without the user's specific instruction. The selection of the percentage of saturation may also performed done manually without an input device such as a DVD controller or mouse. For instance, a system may include different CD-ROMs or different DVDs, each one including a passage (e.g., a story) with a different saturation percentage. When the user wants to select a particular saturation percentage, the user selects a specific CD-ROM or DVD with the appropriate saturation percentage and may thereafter use it with an appropriate computer or DVD player, respectively.

The substitution of target language words into the narration and/or text is preferably systematic. One method of performing systematic substitution of target language vocabulary into native language presentation comprises the following steps: perform a concordance on the words used in the passage to determine the frequency with which each word used is repeated; (b) determine whether the repeated words are used with the same meaning; (c) determine the importance of a repeated word (i) to the story (or other passage), and (ii) to the user's general vocabulary base (that is, are the words “bridge words”, “building block words”, “non-substantive words” or “flavoring words”); and (d) weight the above factors.

A concordance analysis counts the number of individual occurrences of any particular word in a text. For instance, a concordance of the previous sentence would be as follows, with the number of occurrences in parentheses:

of (2);

a (2);

concordance (1);

analysis (1);

counts (1);

the (1);

number (1);

individual (1);

occurrences (1);

any (1);

particular (1);

word (1);

in (1);

text (1).

The concordance analysis provides the number of times that a word is repeated in a passage. It is a measure of how useful it might be for a user to have that word in his or her vocabulary. Repeating new target language words in similar native language contexts allows readers to understand the meanings of the target language words. This is one factor in selecting the order in which a target vocabulary is presented to the user.

The number of times a word is repeated is not the only criteria for determining how and when a target language word is introduced to a user. For example, the relative importance of a word (e.g., as it is used to express a simple idea or and request) may also be a useful criteria. Many words may appear as identical in a concordance, even though they might have vastly different meanings in a passage. For instance, consider the following sentence: “He turned his face to face the clock face in order to check the time and determine whether he could save face, but he had to face the fact that he was late.” The word “face” occurs 5 times in the previous sentence, but each time it has a different meaning. When a word has different meanings in a passage, each meaning can be treated as a different word, rather than as a repetition of the same word. Thus, in the concordance analysis above, the number of times that a word is repeated can take into account whether or not the word that is repeated has the same or similar meaning each time it is used.

It is also desirable to understand, within a concordance analysis, the function of a word in a narrative passage. This is because some words are needed to understand a passage. These words may be referred to as “bridge words”. For instance, in a story about a lost puppy, the words “puppy” and “lost” would be bridge words. Without knowing these words, one could not understand the story.

There are also words, which are substantive words, that form a usable vocabulary that is needed to fully understand a passage, but are not critical to understanding the general nature of the passage. These are called “building block” words. Examples of building block words include “good”, “bad”, “fast”, “slow”, “hello”, “blue”, “black”, etc.

Another category of words are “non-substantive” words. These can be omitted with very little loss in comprehension. Non-substantives might include some prepositions (depending on context), as well as the indefinite and definite articles and some modifiers. Although a passage may contain critical words (bridge words), building block words and non-substantive words, it is the “flavoring” words that give the text its unique character. These words also illustrate the style of the author of the passage. These words might be colorful, out of context, reflect unusual or metaphorical language or may involve other stylistic elements. Although not critical to an understanding of the substance of a passage, these words help an audience understand the distinctiveness and flavor of that passage and are useful in keeping the audience engaged.

While all the various word forms have a place in a language student's vocabulary, a substitution methodology is effective in part because it assigns weights to the various types of words identified above and uses them to build substitution strategy appropriate for the user. The user is most likely to retain substituted words that are either bridge words or flavoring words. Therefore, although these words are often low frequency, these words can be substituted aggressively and early, but with a high level of repetition or context to make sure that they are understood.

Repetition helps a student learn a new language. For example, for a short story that is 200-400 words long, it takes about 3 to 7 repetitions for a student to retain a target language word in the story. Of course, a better student may learn with fewer repetitions, while a challenged student may require more repetitions. Embodiments of the invention advantageously allow a student to repeat known target language words as the student increases the target language saturation level with each subsequent playback of the passage to be learned.

Although students are often most interested in learning building block words from a story, these often require more repetition than flavoring or bridge words. Therefore, building block words often require presentation in context multiple times before a student can be assumed to know them in various contexts. The number of repetitions that may be needed to learn building block words can be between about 5 and 15 in a 200 word to 400 word story. Of course, a better student may learn with fewer repetitions, while a challenged student may need more repetitions.

Substitution of non-substantive words will have the least effect on comprehension, but will also be retained the least by the student. These opposing factors lead to a wide range of frequencies that can be used for non-substantive words. Because they are not as necessary to comprehend a passage, they need not be emphasized as much as bridge, flavor, or building block words. On the other hand, because they are more difficult to retain, it may be desirable to repeat them.

With the above information in mind, embodiments of the present invention include a method for weighting the relative number of times that bridge, flavor, building block, or non-substantive words are repeated. For example, in some embodiments, of the total number of words substituted, between about 50% and about 75% can be bridge words. Between about 5% and about 25% of the total words substituted can be flavor words. Between about 5% and about 25% of the total words substituted are building block words. And between about 5% and about 10% are non-substantive words.

Various other rules for target language word presentation and/or substitution may also be used. The rules may be objective, subjective, or partially subjective and partially objective. The following is a description of some steps that may be used in a process for creating a language learning device or memory medium according to an embodiment of the invention. In the process, any of the steps can be omitted, and the steps may be combined in any manner, with or without other steps described in this application.

First, decide on the level of saturation over time. In other words, over any given number of words or minutes, determine how quickly target language words will be introduced to the user. This can depend on the user's age, level of interest, level of facility, difficulty in learning the language, etc.

Second, determine a saturation percentage for the target language words in the passage. This may be generally from an initial setting of 5% to a more aggressive initial setting of 20%.

Third, determine the number of levels. This determines which words will be selected for insertion. Generally, the larger number of levels, the more difficult the material or the more challenged the user.

Fourth, run the text of the passage (e.g., a narrative or script of a movie, TV show, or story) though a concordance program (as noted above).

Fifth, take the concordance results and differentiate between synonyms and cognates. Treat synonyms as slightly more difficult than ordinary words and treat cognates as less difficult.

Sixth, compare the concordance output to the standard word list appropriate for the length and complexity of the material and for the user's goals. For instances, if the user is a beginner adult student that is using a cartoon 10 minutes in length, one might compare the concordance of the 50 and/or the most 100 most frequently used words in the word index. For longer material, the top 250, 500, 750, or top 1000 words might be selected. The target list vocabulary is then isolated.

Seventh, build an initial target list of words that are both repeated the most and carry the highest frequency number.

Eighth, substitute cognates from the target list of words first. It may be desirable to ensure that that there are no “clumps” or chunks of target language words in the passage where the target language words become too dense.

Ninth, insert additional words (if necessary) to get to the desired saturation percentage.

Tenth, optionally choose at least 5% of the total saturation words based on a characteristic of euphony or serendipity to lend authenticity to the text of the passage.

Eleventh, repeat steps 1-10 for each saturation percentage.

In some situations, it is desirable to build confidence in the student, rather than to aggressively introduce the student to new and possibly difficult words. To accommodate this situation, a student (or teacher) may have the option of selecting an “easiest” substitution mode. In this type of substitution mode, a higher percentage of non-substantive words may be substituted. For example, between about 15% and about 25% of the native words substituted in a passage may be non-substantive words, in order to give the student a feeling of accomplishment. This is particularly useful if the student has trouble retaining the meanings of substituted words. Although non-substantive words are typically not retained as well as building block or bridge words, allowing the user to proceed in this manner may help to motivate the student and may improve the recognition of sounds of the target language.

Juxtaposition and substitution are two methods that can be used for progressively increasing the percentage of target language words in a passage. In substitution, a target language word or phrase is simply substituted for the corresponding native language word or phrase in a passage.

In juxtaposition, the native language word or phrase, and the target language word or phrase, appear together adjacent to each other. This can help the user with a difficult passage and can be used as a light repetition method or a way to reinforce target vocabulary. Juxtaposition interrupts the flow of a given passage more than substitution does, and thus juxtaposition is preferred only as an intermediate means for those passages which are difficult to understand. One example is false cognates, which can mislead students. The following sentences illustrate this principle: “The woman became embarazada (pregnant). This made her husband happier than if he had just won a billion (trillion) dollars. He promised he would be especially bizarro (generous) with assisting her.” The visual presentation of the juxtaposition of native and target language words or phrases may occur using any visual aid including parentheses, superscripts, subscripts, bolded text, etc. Alternatively, the juxtaposed translation can be presented in a “voice-over” where the words can be pronounced as an aside, or in slightly different tones of voice.

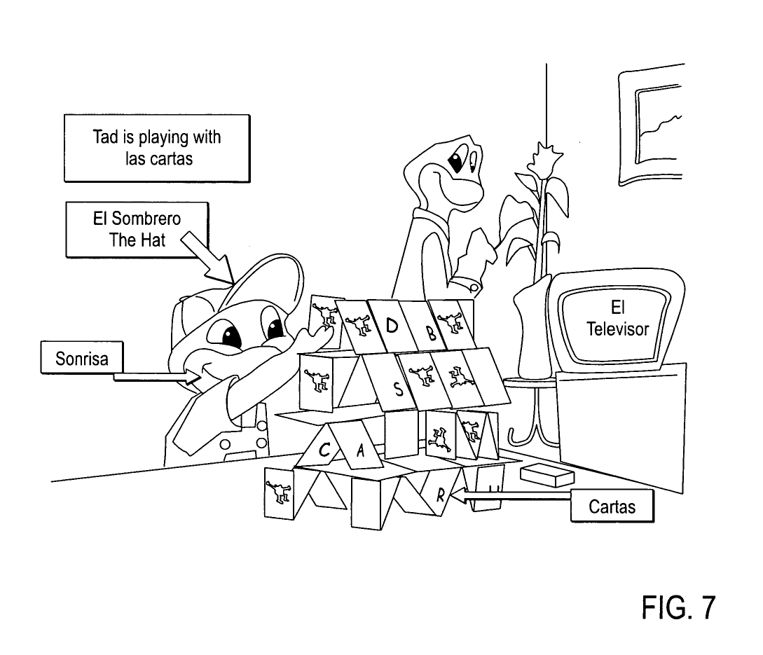

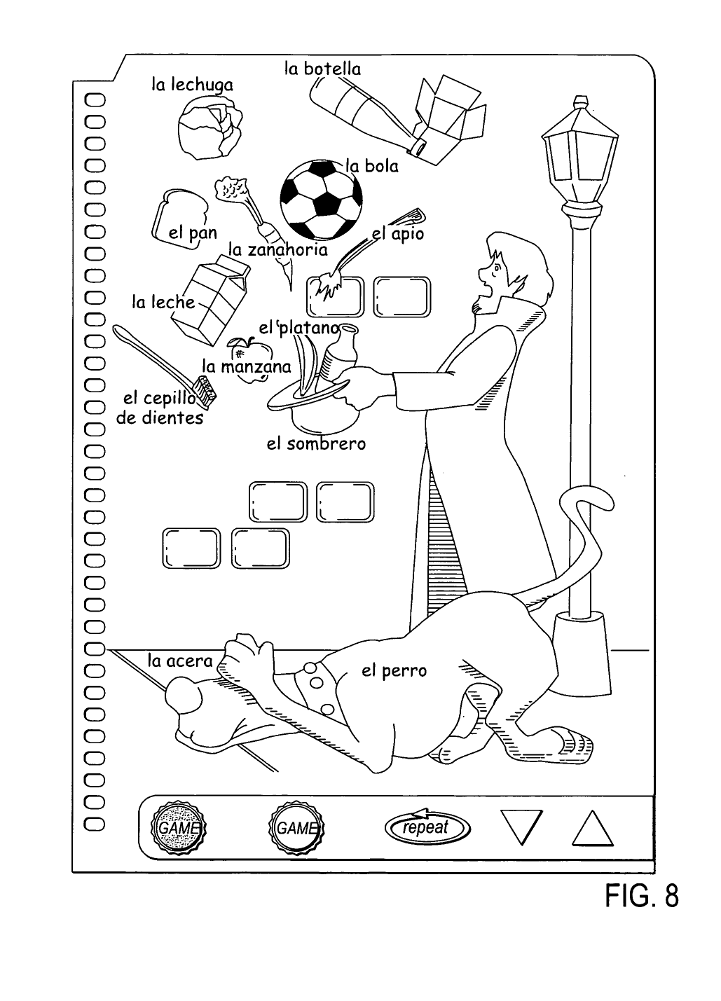

FIG. 7 shows a screenshot from a DVD program. The screenshot shows native language words (English) juxtaposed with target foreign language words (Spanish). Images that are associated with the target and native language words are also shown. In this example, juxtaposition is used when an object might be a hat or a head or a frog to help clarify what is intended. In addition, the particular language that accompanies this image uses a substitution word, las cartas, the meaning of which is discernable not just from the story but also from the particular video image itself, which aids in the comprehension and retention of substituted words.

The above-described embodiments describe the use of video and audio to teach a user a target language. However, one way to expand the user's learning process is to use books in conjunction with audio and video. For example, a video may present an interesting story to the user, but may not provide the user with complete knowledge with a category of vocabulary. For example, the story may involve a human character that is walking his male dog. A small brown female dog makes romantic eyes at the male dog, who wants to stop. The human tells the male dog to “keep going”. This angers the female dog, who then kicks a trash can, sending the trash in it flying into the air. The human character catches the trash, and keeps the male dog from getting dirty. The trash can contents includes ordinary household items. One partial illustration of this scene is shown in FIG. 7. FIG. 7 shows a page from an interactive book.

The contents of the trash can provide an excellent opportunity to enhance the user's vocabulary of household items. However, the audio associated with a video showing this particular story may not recite all of the items. Rather, to maintain the viewer's interest, the audio may only recite a few such household items. In this case, a textbook or an interactive book that accompanies the video presentation may augment the user's learning experience.

U.S. Provisional Application No. 60/418,741 shows sample illustrations and words in a target language (Spanish) that are used to augment a learning experience for the scene just described. The principle would be the same in any accompanying gradual immersion interactive video device. For example, an interactive DVD performing the interactive methods described above may mention some color such as “rojo” for red. However, there may not be opportunity to include colors other than red into the into the DVD video story line. A page in an interactive book apparatus such as those described in U.S. Pat. Nos. 6,661,405 and 6,668,156 (which are herein incorporated by reference in their entirety), may have a color palate having a plurality of colors on it. In the interactive book apparatus, the user selects each color by pointing to it with a stylus, and an audio signal that is generated by the book apparatus produces a voice that says the word in Spanish (or in English), so that the user hears it pronounced correctly. The user can touch a blank at the bottom of the page, then an object so that a sentence is created. For example, the sentence created may be: “El perro” ate a giant “plantano” “amarillo”. This is translated as “The dog ate a giant yellow banana.” By making up silly sentences with the interactive book apparatus, the user begins to learn vocabulary that is more extensive than the vocabulary in the DVD video.

Embodiments of the invention have a number of advantages. As noted above, embodiments of the invention can be used to “gradually” immerse a user, such as a child, in a target foreign language. The most successful second language learners are those who enter a new culture and learn by immersion, and are children who are raised with two languages simultaneously. These children go through a phase of grammatical and lexical mixing which seems to be a highly valuable and necessary step for them. There is something fundamental about language mixing to the language acquisition process itself. Using embodiments of the invention, learners can be gradually exposed to larger quantities of target foreign language words so that the learners do not “feel” like they are studying the target foreign language. In addition, using embodiments of the invention, a user can set a customized learning pace that is highly efficient and effective.

Any of the above functions described above may be embodied as computer code in a memory medium such as a computer readable medium. The computer code may be created by those of ordinary skill in the art using any suitable programming language including C, C++, etc. The code may be executed by any processor known to those of ordinary skill in the art.

Embodiments of the invention can also be implemented on other suitable hardware including the apparatus described in U.S. patent application Ser. No. 10/775,830, filed on Feb. 9, 2004, which is incorporated by reference in its entirety. This apparatus is a hand held gaming device with a stylus and a directional pad. Embodiments of the invention may also be implemented using a client-server architecture and may use the Internet.

The terms and expressions which have been employed in this document are used as terms of description and not of limitation, and there is no intention in the use of such terms and expressions of excluding equivalents or portions of the features shown and described, it being recognized that various modifications are possible within the scope of invention the claimed. Moreover, one or more features of embodiments of the invention may be combined any one or more features of other embodiments of the invention without departing from the spirit and scope of the invention.

All patent applications, publications, and patents noted above are herein incorporated by reference in their entirety for all purposes.

Any recitation of “a”, “an”, and “the” as used herein is intended to mean “one or more” unless specifically indicated to the contrary.

What is claimed is:

1. A method comprising:
presenting a passage to a user through one of an audio output device and a display device, wherein the passage comprises words in the user's native language and words in the user's target language;
adjusting a percentage of words in the user's target language in the passage to arrive at an adjusted percentage; and
presenting the passage to the user through one of the audio output device and the display device using the adjusted percentage of words in the user's target language.

2. The method of claim 1 wherein the passage is presented to the user using the audio output device and the display device.

3. The method of claim 1 wherein adjusting the percentage of words is performed in response to a user interacting with an interface element.

4. The method of claim 1 wherein the adjusted percentage is between 1% and 99%.

5. The method of claim 1 wherein said presenting the passage to the user through one of the audio and the display device using the adjusted percentage of words in the user's target language comprises presenting the target language words and corresponding native language words in juxtaposed positions.

6. The method of claim 1 wherein said presenting the passage to the user through one of the audio and the display device using the adjusted percentage of words in the user's target language comprises substituting the target language words for corresponding native language words in the passage.

7. The method of claim 1 wherein said presentings are performed using a DVD player.

8. The method of claim 1 wherein said adjusting the percentage of words is performed automatically.

9. The method of claim 1 further comprising determining which words in the passage are from the group comprising: bridge; building block; and non-substantive words, and presenting at least some of any bridge and building block words as target language words in the passage before presenting any non-substantive words as target language words in the passage.

10. The method of claim 1 further comprising determining which words in the passage are of the group comprising: bridge block; building block; and non-substantive words, and weighting at least two words.

11. A memory medium comprising:
code for presenting a passage to a user through one of an audio output device and a display device, wherein the passage comprises words in the user's native language and words in the user's target language;
code for adjusting a percentage of words in the user's target language in the passage to arrive at an adjusted percentage; and
code for presenting the passage to the user through one of the audio output device and the display device using the adjusted percentage of words in the user's target language.

12. The memory medium of claim 11 further comprising code for presenting the passage to the user using the audio output device and the display device.

13. The memory medium of claim 11 further comprising code for allowing the user to adjust the percentage of words.

14. The memory medium of claim 11 wherein the memory medium is a DVD.

15. The memory medium of claim 11 further comprising code for presenting the target language words and corresponding native language words in juxtaposed positions.

16. The method of claim 1 further comprising code for substituting the target language words for corresponding native language words in the passage.

17. The memory medium of claim 11 wherein the adjusted percentage is between 1% and 99%.

18. The memory medium of claim 11 further comprising code for automatically adjusting the percentage of words.

19. The memory medium of claim 11 further comprising code for determining which words in the passage are of the group comprising: bridge; building block; and non-substantive words, and then weighting those words.

20. A system comprising:
a memory medium comprising:
code for presenting a passage to a user through one of an audio output device and a display device, wherein the passage comprises words in the user's native language and words in the user's target language;
code for adjusting a percentage of words in the user's target language in the passage to arrive at an adjusted percentage; and
code for presenting the passage to the user through one of the audio output device and the display device using the adjusted percentage of words in the user's target language; and
a book comprising printed information that relate to the passage.

21. A foreign language learning device for learning a foreign language comprising:
an audio output device and a display device adapted to provide a user-controllable presentation; and
a memory medium coupled to the audio output and display devices, wherein the memory medium comprises:
code for audio for target language words and native language words in a passage;
code for providing visual images related to and coordinated with the audio; and
code for responding to a user selection of a percentage of the target language words to be presented along with the native language words in the passage.

22. The device of claim 21 wherein the percentage is between about 5% and about 95%.

23. The device of claim 23 wherein the visual images comprise written text for the passage.

24. The device of claim 21 wherein the visual images comprise images relating to text corresponding to the passage.

25. The device of claim 21 further comprising a processor operatively coupled to the memory medium.
